(19) United States
(12) Patent Application Publication
(10) Pub. No.: US 2014/0305695 A1
(43) Pub. Date: Oct. 16, 2014

(54) Flat Connector and Bulkhead Mounting Structure

(71) Applicant: Tyco Electronics Japan G.K., Kanagawa (JP)

(72) Inventor: Shinichi Hashimoto, Kanagawa (JP)

(73) Assignee: Tyco Electronics Japan G.K., Kanagawa (JP)

(21) Appl. No.: 14/251,118

(22) Filed: Apr. 11, 2014

(30) Foreign Application Priority Data
Apr. 12, 2013 (JP) 2013-084147

(51) Int. Cl. H02G 3/22

(52) U.S. Cl. CPC H02G 3/22
USPC 174/650

(57) ABSTRACT

A flat connector is provided. The flat connector includes a base, an electrical connection portion and a soldering layer. The base includes an end face, an inner surface positioned adjacent the end face, and an outer surface positioned on an opposite side with respect to the inner surface. The electrical connection portion electrically connects the inner surface and the outer surface and, while the soldering layer is provided along the end face.

### CROSS-REFERENCE TO RELATED APPLICATIONS

This application claims priority under 35 U.S.C. §119 to Japanese Patent Application No. 2013-084147 filed on Apr. 12, 2013.

### FIELD OF THE INVENTION

The invention relates to a connector and, in particular, to a flat connector attached to a bulkhead.

### BACKGROUND

There is a demand for electrically interconnecting an inside and an outside of an air-tight chamber defined by a bulkhead. For example, in a manufacturing process of a semiconductor chip on which an integrated circuit is mounted, a vacuum chamber whose inside can be pressure-reduced down to a near-vacuum state is used and the inside and the outside of the vacuum chamber are electrically connected to each other. Further, pressure reduction is also performed by filling the inside of the air-tight chamber defined by the bulkhead with gas having a small molecular weight, for example, helium (He) gas or hydrogen (H) gas. When the inside and the outside of the air-tight chamber are electrically connected to each other, where the pressure has been adjusted, a secure electrical connectivity between the inside and the outside of the chamber is required while air tightness inside the chamber is maintained.

A known flat connector used to electrically interconnect an inside and an outside of an air-tight chamber defined by a bulkhead and a bulkhead mounting structure provided with the flat connector, for example, is shown in FIG. 12 is known (see JP 2013-37890 A).

A known bulkhead mounting structure 101 shown in FIG. 12 includes a flat connector 102 attached to a bulkhead 120. The flat connector 102 electrically interconnects an inside A side and an outside B side of a inner chamber (not shown) which is defined by a bulkhead 120 and whose internal pressure is adjusted.

In the known bulkhead mounting structure 101, an receiving space 121 extending through the inside A side and the outside B side of the chamber is formed in the bulkhead 120. The receiving space 121 is closed by the flat connector 102.

Here, the flat connector 102 includes a base 110 for closing the receiving space 121. The base 110 is an insulating plate member having an inner surface 110a positioned to face the inside A side of the chamber, an outer surface 110b on the side opposite to the inner surface 110a, and a side face 110c connecting a peripheral edge of the inner surface 110a and a peripheral edge of the outer surface 110b so as to go round. The side face 110c includes a first side face portion 110d connecting to the peripheral edge of the inner surface 110a and a second side face portion 110e connecting to the peripheral edge of the outer surface 110b. The first side face portion 110d has an outer diameter larger than an outer diameter of the receiving space 121 of the bulkhead 120. The second side face portion 110e has an outer diameter larger than the outer diameter of the first side face portion 110d to be formed in a shape bulging beyond the first side face portion 110d.

Further, the base 110 includes a plurality of electrical connection portions 114 for electrically connecting the inner surface 110a and the outer surface 110b of the base 110 to each other. Each electrical connection portion 114 is an annular conductive section 112 provided on an inner circumferential face of a receiving passageway 111 extending through between the inner surface 110a and the outer surface 110b of the base 110, and a filler 113 filled in an inside of the conductive section 112. The conductive section 112 electrically connects the inner surface 110a and the outer surface 110b of the base 110. Further, the filler 113 is filled in the inside of the conductive section 112 and has a function for securing air tightness of the inside A side and the outside B side of the chamber.

Further, a soldering layer 115 is provided on a whole circumference of the peripheral edge of the inner surface 110a of the base 110 and a whole circumference of the peripheral edge of the first side face portion 110d.

In the flat connector 102, the inner surface 110a of the base 110 is disposed toward the side of the receiving space 121 of the bulkhead 120 and the soldering layer 115 is connected to the outer surface 120b of the bulkhead 120 through a solder S.

Thereby, secure electrical connectivity between the inside A and the outside B of the chamber can be obtained while air tightness on the inside A side of the chamber can be held.

However, in the known bulkhead mounting structure 101 shown in FIG. 12, there is the following problem.

That is, the base 110 forming the flat connector 102 has a predetermined thickness. Therefore, in a state where the flat connector 102 has been secured to the bulkhead 120, the thickness of the flat connector 101 in addition to the thickness of the bulkhead 120 is also at least required in the thickness direction of the bulkhead 120. Consequently, there is such a problem that the thickness of the whole bulkhead mounting structure 1 cannot be made thin so that reduction in height thereof cannot be achieved.

### SUMMARY

The present invention has been made in view of this problem, and an object thereof, among others, is to provide a flat connector having a base, an electrical connection portion and a soldering layer. The base includes an end face, an inner surface positioned adjacent the end face, and an outer surface positioned on an opposite side with respect to the inner surface. The electrical connection portion electrically connects the inner surface and the outer surface and, while the soldering layer is provided along the end face.

### BRIEF DESCRIPTION OF THE DRAWINGS

The invention is explained in greater detail below with reference to embodiments with reference to the appended drawings. In the detailed Figures:

FIG. 1 is a section view of a bulkhead mounting structure according to the invention;

FIG. 2A is plan view of a flat connector according to the invention for the bulkhead mounting structure shown in FIG. 1;

FIG. 2B being a sectional view of the flat connector of FIG. 2A, taken along line 2B-2B in FIG. 2A;

FIG. 3 is a sectional view showing a main section of the bulkhead mounting structure shown in FIG. 1;

FIG. 4 is a sectional view of another flat connector according to the invention;

FIG. 5 is sectional view of the flat connector shown in FIG. 4 after being attached to the bulkhead mounting structure;

FIG. 6 is a sectional view of the invention of the flat connector shown in FIG. 4 that is attached to another bulkhead mounting structure according to the invention;

FIG. 7A is plan view of another flat connector according to the invention;

FIG. 7B being a sectional view of the flat connector of FIG. 7A, taken along line 7B-7B in FIG. 7A;

FIG. 8A is plan view of a first connector and a second connector of a flat connector according to the invention;

FIG. 8B being a sectional view of the flat connector of FIG. 8A, taken along line 8B-8B in FIG. 8A;

FIG. 9 is a sectional view of a bulkhead mounting structure according to the invention, taken along line 9-9 in FIG. 8B, where the first connector is omitted;

FIG. 10 is a sectional view of the bulkhead mounting structure shown in FIG. 9, where the first connector is omitted;

FIG. 11A is plan view of a first connector and a second connector of another flat connector according to the invention;

FIG. 11B being a sectional view of the flat connector of FIG. 11A, taken along line 11B-11B in FIG. 11A; and

FIG. 12 is a sectional view of a known bulkhead mounting structure having a connector attached to the bulkhead mounting structure.

### DETAILED DESCRIPTION OF THE EMBODIMENT(S)

The invention is explained in greater detail below with reference to the Figures

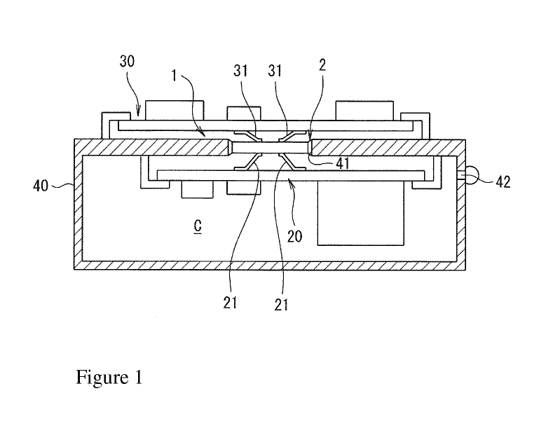

With respect to FIG. 1, a bulkhead mounting structure according to the invention is shown and includes a bulkhead 40 and a flat connector 2 attached to the bulkhead 40. In the bulkhead mounting structure 1, an inside and an outside of an air-tight chamber C which is defined by the bulkhead 40 and whose inside is kept air-tight is electrically interconnected to each other. The inside of the air-tight chamber C may be put in a near-vacuum state or may be pressure-reduced down to a pressure state lower than outside pressure by filling the air-tight chamber C with gas having a small molecular weight, for example, helium (He) gas or hydrogen (H) gas. Further, the inside of the air-tight chamber C may be put in a pressure state higher than the outside pressure.

Here, the bulkhead 40 is formed with a receiving space 41 extending through the inside and the outside of the air-tight chamber C. Further, the bulkhead 40 is formed with a gas-charging receiving passageway 42 for charging gas in the air-tight chamber C of the bulkhead 40. The bulkhead 40 is made of metal.

As shown in FIG. 1, the receiving space 41 of the bulkhead 40 is closed by the flat connector 2.

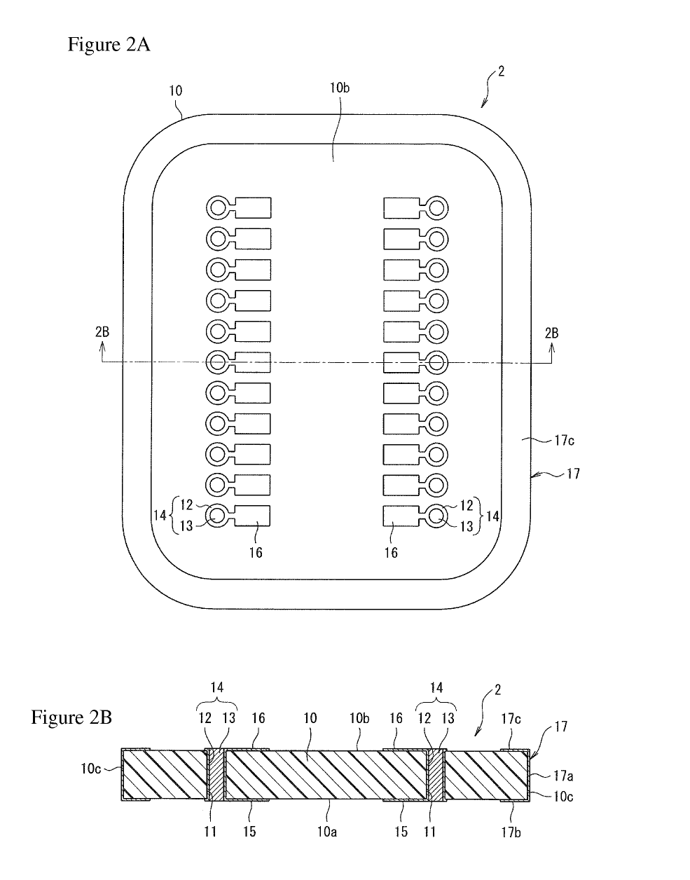

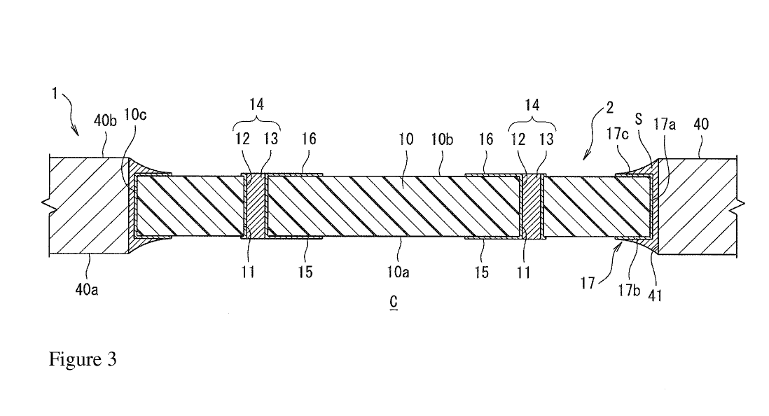

As shown in FIGS. 2A and 2B, and FIG. 3, the flat connector 2 includes a base 10 to be disposed within the receiving space 41. As shown in FIGS. 2A and 2B, the base 10 is a flat member with an approximately rectangular shape having a predetermined thickness and extending in a width direction (in a horizontal direction in FIG. 2A) and in a longitudinal direction (in a vertical direction in FIG. 2A). The base 10 is a single base, and the flat connector 2 is a double-sided board having an inner conductive layer 15 and an outer conductive layer 16 electrically connected to an inner surface 10a and an outer surface 10b of the base 10 (described later) by electrical connection portions 14, respectively. As shown in FIG. 3, an outside dimension of the base 10 is approximately the same as or slightly smaller than a dimension of an inner diameter of the receiving space 41 so as to be disposed within the receiving space 41 of the bulkhead 40. As shown in FIG. 3, the base 10 has the inner surface 10a arranged toward the inside of the air-tight chamber C, the outer surface 10b on the side opposite to the inner surface 10a, and a end face 10c. The base 10 is made of, for example, epoxy resin containing glass. As shown in FIG. 3, the thickness of the base 10 is thinner than the thickness of the bulkhead 40, and the inner surface 10a and the outer surface 10b of the base 10 are positioned inside an inner surface 40a and an outer surface 40b of the bulkhead 40, respectively, in a state where the base 10 has been disposed within the receiving space 41.

Further, a plurality of electrical connection portions 14 for electrically interconnecting the inner surface 10a and the outer surface 10b of the base 10 are provided on the base 10. As shown in FIGS. 2A and 2B, the plurality of electrical connection portions 14 are formed in two lines in a width direction of the base 10. The electrical connection portions 14 in each line are arranged at a predetermined pitch along the longitudinal direction of the base 10. Each electrical connection portions 14 is an conductive section 12 provided on an inner circumferential face of a receiving passageway 11 extending through between the inner surface 10a and the outer surface 10b of the base 10, and a filler 13 filled in the conductive section 12. As shown in FIG. 2B, the conductive section 12 extends through between the inner surface 10a and the outer surface 10b of the base 10. The side of the inner surface 10a of each conductive section 12 is connected to the inner conductive layer 15 with a rectangular shape formed on the inner surface 10a of the base 10. On the other hand, the side of the outer surface 10b of the conductive section 12 is connected to the outer conductive layer 16 with a rectangular shape formed on the outer surface 10b of the base 10. Each conductive section 12 is formed of tin plating or gold plating. Since the filler 13 has been filled in the conductive section 12, permeability of gas can be suppressed effectively. In this embodiment, as the filler 13, solder which is electrically conductive is used. When the conductive solder is used as the filler 13, electrical connection between the inner surface 10a and the outer surface 10b of the base 10 can be achieved securely and in addition thereto, when gas which has been filled in the inside of the air-tight chamber C moves from the inside of the air-tight chamber C to the outside, the movement can be blocked effectively by the solder. Incidentally, the filler 13 is not necessarily required to have electrical conductivity, but it may be resin having air tightness.

Further, as shown in FIGS. 2A and 2B and FIG. 3, a soldering layer 17 is provided on a whole circumference of the end face 10c of the base 10. The soldering layer 17 includes a first soldering layer 17a formed on a whole circumference of the end face 10c of the base 10. Further, the soldering layer 17 includes a second soldering layer 17b continuous with the first soldering layer 17a and formed on a whole circumference of a peripheral edge of the inner surface 10a of the base 10. Further, the soldering layer 17 includes a third soldering layer 17c continuous with the first soldering layer 17a and formed on a whole circumference of a peripheral edge of the outer surface 10b of the board 10. As shown in FIG. 3, the first soldering layer 17a, the second soldering layer 17b and the third soldering layer 17c forming the soldering layer 17 are soldered to the inner wall of the receiving space 41 of the bulkhead 40. The soldering layer 17 is formed of, for example, tin plating or gold plating.

Next, when the inside and the outside of the air-tight chamber C are electrically interconnected to each other using the flat connector 2, as shown in FIG. 1, a first circuit board 20 is first disposed within the air-tight chamber C. The base 10 of the flat connector 2 is disposed within the receiving space 41 of the bulkhead 40 such that the inner surface 10a of the flat connector 2 is directed to the inside of the air-tight chamber C, as shown in FIG. 3. At this time, positioning of the flat connector 2 to the bulkhead 40 is performed while the flat connector 2 is being supported from the inside side of the air-tight chamber C by a jig (not shown). In this state, the soldering layer 17 of the flat connector 2 is soldered to the inner wall of the receiving space 41 by solder S. Thereby, the flat connector 2 is secured to the inner wall of the receiving space 41 and the receiving space 41 is closed by the flat connector 2. Further, the inner conductive layer 15 of the flat connector 2 comes in contact with contacts 21 provided on the first circuit board 20.

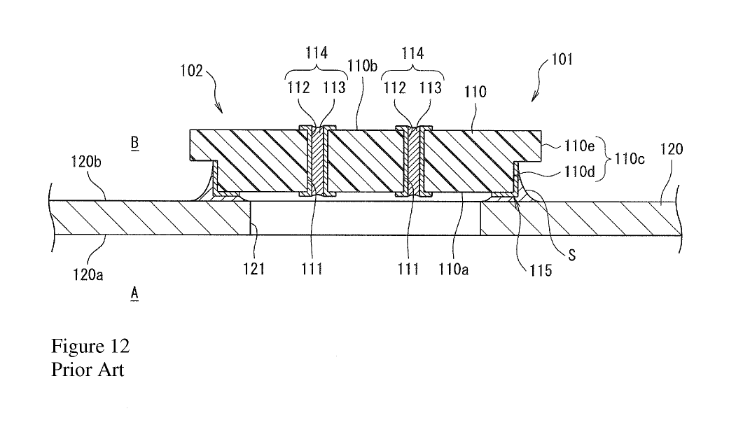

Since the soldering layer 17 is provided on the whole circumference of the end face 10c of the base 10, the soldering layer 17 is soldered to the inner wall of the receiving space 41 by the solder S where the base 10 of the flat connector 2 has been disposed within the receiving space 41. Thereby, as shown in FIG. 3, the flat connector 2 is secured to the inner wall of the receiving space 41 and the receiving space 41 is closed by the flat connector. Therefore, when the flat connector 2 has been secured to the bulkhead 40, the thickness of the bulkhead 40 and the thickness of the flat connector 2 overlap with each other in the receiving space 41 of the bulkhead 40. Thereby, the thickness of the bulkhead mounting structure 1 in the thickness direction of the bulkhead 40 can be made thin so that height reduction of the bulkhead mounting structure 1 can be achieved. In the case of the embodiment shown in FIG. 3, since the thickness of the flat connector 2 is thinner than the thickness of the bulkhead 40, the thickness of the bulkhead mounting structure 1 in the thickness direction of the bulkhead 40 becomes equal to the thickness of the bulkhead 40. On the other hand, the thickness of the known bulkhead mounting structure 101 shown in FIG. 12 is the sum of the thickness of the flat connector 2 and the thickness of the bulkhead 40, which is thicker than the thickness of the bulkhead mounting structure 1 of this embodiment.

Further, since the soldering layer 17 of the flat connector 2 is provided on the whole circumference of the end face 10c of the base 10, soldering is performed over the whole circumference of the inner wall of the receiving space 41. Therefore, the flat connector 2 can be secured to the inner wall of the receiving space 41. Furthermore, a gap between the whole circumference of the end face 10c of the base 10 and the whole circumference of the inner wall of the receiving space 41 can be filled with the solder S, so that when the gas which has been filled in the air-tight chamber C moves from the inside of the air-tight chamber C toward the outside, movement thereof can be blocked effectively by the solder S.

Further, the solder layer 17 includes not only the first soldering layer 17a formed on the whole circumference of the end face 10c of the base 10 but also the second soldering layer 17b formed on the whole circumference of the peripheral edge of the inner surface 10a of the base 10 and the third soldering layer 17c formed on the whole circumference of the peripheral edge of the outer surface 10b of the base 10. Therefore, as shown in FIG. 3, not only the first soldering layer 17a but the second soldering layer 17b and the third soldering layer 17c are also connected to the inner wall of the receiving space 41 by the solder S. Thereby, the flat connector 2 can be more secured to the inner wall of the receiving space 41.

Further, in the flat connector 2, the base 10 is a single base. The flat connector 2 is a double-sided board having two conductive layers of the inside conductive layer 15 and the outer conductive layer 16 connected to an inner surface 10a and an outer surface 10b of the single base 10 using the electrical connection portions 14. Thereby, in the bulkhead mounting structure 1 where the flat connector 2 composed of the double-sided board has been attached to bulkhead 40, the thickness of the bulkhead mounting structure 1 in the thickness direction of the bulkhead 40 can be made thin.

After the jig (not shown) is removed, as shown in FIG. 1, contacts 31 provided on a second circuit board 30 are connected to conductive pads 16 on the outer surface 10b of the flat connector 2. Thereby, the first circuit board 20 and the second circuit board 30 are electrically interconnected to each other using the flat connector 2.

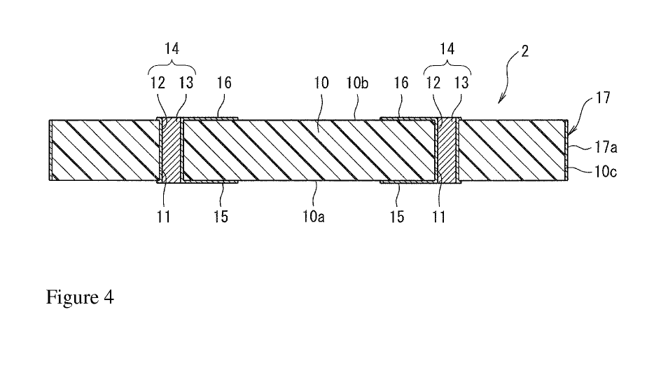

With reference to FIG. 4, another flat connector 2 will be described. In FIG. 4, same elements as those shown in FIGS. 2A and 2B are used with same reference numerals and explanation thereof may be omitted.

A flat connector 2 shown in FIG. 4 has the same basic configuration as that of the flat connector 2 shown in FIGS. 2A and 2B, but the both are different in configuration of the soldering layer 17 from each other.

The soldering layer 17 in the flat connector 2 shown in FIGS. 2A and 2B includes not only the first soldering layer 17a but also the second soldering layer 17b and the third soldering layer 17c.

On the other hand, a soldering layer 17 in the flat connector 2 shown in FIG. 4 includes a first soldering layer 17a formed on the whole circumference of the end face 10c of the base 10. The first soldering layer 17a extends from the inner surface 10a of the base 10 to reach the outer surface 10b.

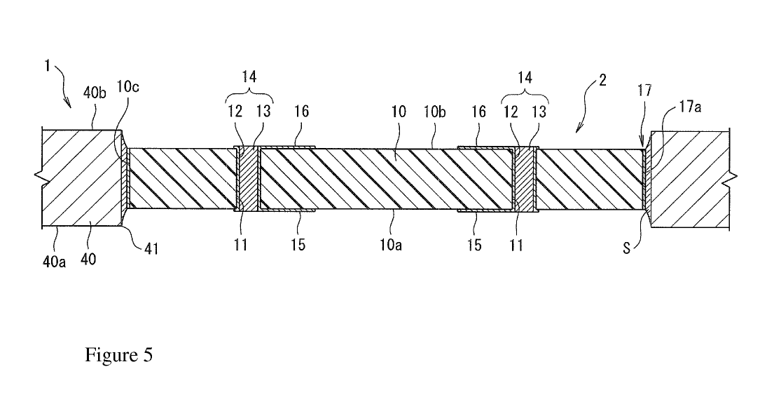

Even if the soldering layer 17 only includes the first soldering layer 17a formed on the whole circumference of the end face 10c of the base 10 in this manner, as shown in FIG. 5, the flat connector 2 can be secured to the inner wall of the receiving space 41. Further, the receiving space 41 can be closed by the flat connector 2. In addition, in the bulkhead mounting structure 1 where the flat connector 2 has been attached to the bulkhead 40, the thickness of the bulkhead mounting structure 1 in the thickness direction of the bulkhead 40 can be made thin.

Since the soldering layer 17a of the flat connector 2 is provided on the whole circumference of the end face 10c of the base 10, soldering is performed on the whole circumference of the inner wall of the receiving space 41. Therefore, the flat connector 2 can be secured to the inner wall of the receiving space 41. Furthermore, a gap between the whole circumference of the end face 10c of the base 10 and the whole circumference of the inner wall of the receiving space 41 can be filled with the solder S. Therefore, when the gas which has been filled in the air-tight chamber C moves from the inside of the air-tight chamber C toward the outside, movement thereof can be blocked effectively by the solder S.

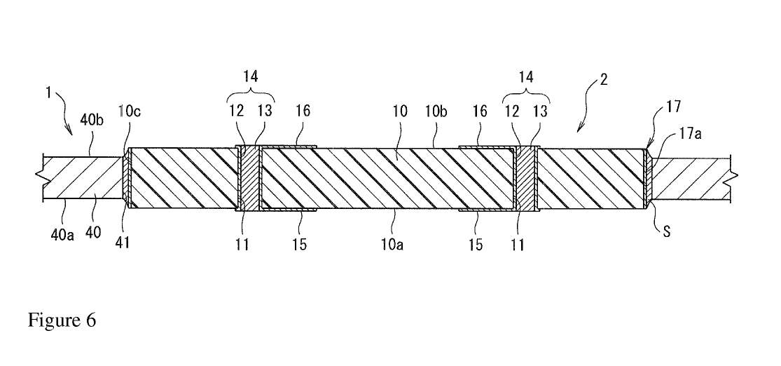

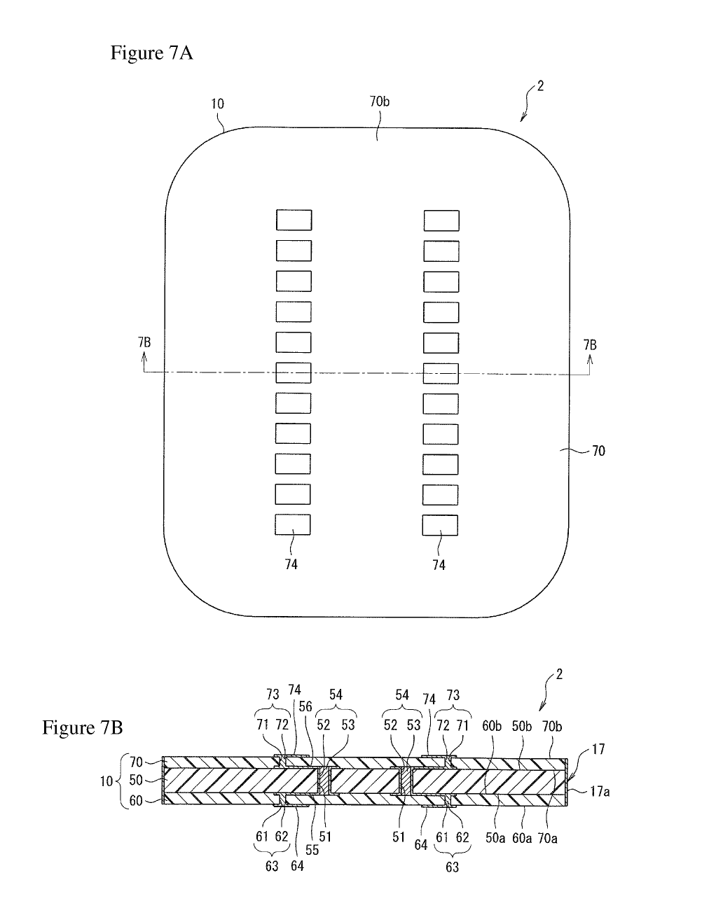

Incidentally, in the bulkhead mounting structure 1 where the flat connector 2 shown in FIG. 4 has been attached to the bulkhead 40, as shown in FIG. 6, the thickness of the bulkhead 40 may be made thinner than the thickness of the flat connector 2. On the contrary, such a configuration can be adopted that the thickness of the flat connector 2 is made thicker than the thickness of the bulkhead 40 and the inner surface 10a and the outer surface 10b of the base 10 project from the inner surface 40a and the outer surface 40b of the bulkhead 40, respectively. Even in this case, the thickness of the bulkhead 40 and the thickness of the flat connector 2 overlap with each other in the receiving space 41 of the bulkhead 40. Therefore, the thickness of the bulkhead mounting structure 1 along the thickness direction of the bulkhead 40 becomes the thickness of the flat connector 2. Therefore, the shown example can be made thinner than the case where the thickness of the known bulkhead mounting structure 101 becomes equal to the sum of the thickness of the flat connector 102 and the thickness of the bulkhead 120. Of course, the thickness of the flat connector 2 may be made thinner than the thickness of the bulkhead 40, as shown in FIG. 5. Further, the thickness of the flat connector 2 shown in FIGS. 2A and 2B and the thickness of a flat connector 2 shown in FIGS. 7A and 7B (described later) may be made thicker or thinner than the thickness of the bulkhead 40, and the formers may be equal to the latter, of course.

As shown in FIGS. 7A and 7B, another flat connector will be described. In FIGS. 7A and 7B, same elements as those shown in FIGS. 2A and 2B are used with same reference numerals and explanation thereof may be omitted.

A flat connector 2 shown in FIGS. 7A and 7B has a basic configuration similar to that of the flat connector 2 shown in FIGS. 2A and 2B. However, the flat connector 2 shown in FIGS. 2A and 2B is composed of the double-sided board, but the flat connector 2 shown in FIGS. 7A and 7B is different from the flat connector in FIGS. 2A and 2B regarding a point where the former is a four-layer board which is a multilayer board.

A base 10 in the flat connector 2 shown in FIGS. 7A and 7B includes stacking three bases of a second base 60, a first base 50 and a third base 70 in this order from the inside to the outside. The flat connector 2 is a four-layer board having four layers of a first conductive layer 64, a second conductive layer 55, a third conductive layer 56, and a fourth conductive layer 74 connected to an inner surface 60a of the second base 60 positioned on an innermost side, an outer surface 70b of the third base 70 positioned on an outermost side, between the second base 60 and the first base 50 adjacent to each other, and between the first base 50 and the third base 70 adjacent to each other by electrical connection portions.

Specifically, the configuration of the flat connector 2 will be described. The base 10 includes the flat first base 50, the flat second base 60 disposed on an inner surface 50a of the first base 50, and the flat third base 70 disposed on an outer surface 50b of the first base 50.

Here, the first base 50 is a flat member with an approximately rectangular shape extending in a width direction (in a horizontal direction in FIG. 7A) and a longitudinal direction (in a vertical direction in FIG. 7A). The first base 50 has the inner surface 50a positioned toward the inside side of the air-tight chamber C (see FIG. 1), and the outer surface 50b on the side opposite to the inner surface 50a. The first base 50 is made of, for example, epoxy resin containing glass.

Further, as shown in FIG. 7B, the first base 50 is formed with a plurality of vias 54 for electrically interconnecting the inner surface 50a and the outer surface 50b of the first base 50. The plurality of vias 54 are formed in two lines in a width direction of the first base 50. Although not illustrated, the vias 54 in each line are formed at a predetermined pitch along the longitudinal direction of the line. Each via 54 includes an annular first conductive section 52 applied to an inner circumferential face of a receiving passageway 51 extending through between the inner surface 50a and the outer surface 50b of the first base 50. The inside of the first conductive section 52 is filled with a filler 53. The first conductive section 52 extends through between the inner surface 50a and the outer surface 50b of the first base 50. The first conductive section 52 is formed of tin plating or gold plating, for example. Further, as the filler 53, conductive solder is used. When the conductive solder is used as the filler 53, electrical connection between the inner surface 50a and the outer surface 50b of the first base 50 can be performed securely and in addition thereto, when gas which has been filled in the inside of the air-tight chamber C moves from the inside of the air-tight chamber C toward the outside thereof, movement of the gas can be blocked effectively by the solder. Thereby, permeability of gas which has been filled in the inside of the air-tight chamber C can be suppressed more effectively. Incidentally, the filler 53 is not necessarily required to have electrical conductivity, but it may be resin.

Furthermore, a plurality of second conductive layers 55 connected to the inner surface 50a side of the first conductive section 52 are provided on the inner surface 50a of the first base 50 between the second base 60 and the first base 50 adjacent to each other. Further, a plurality of third conductive layer 56 connected to the outer surface 50b side of the first conductive section 52 are provided on the outer surface 50b of the first base 50 between the first base 50 and the third base 70 adjacent to each other.

The second base 60 is a flat member with an approximately rectangular shape extending in a width direction (in a horizontal direction in FIG. 7A) and a longitudinal direction (in a vertical direction in FIG. 7A). The second base 60 has a width and a length equal to those of the inner surface 50a of the first base 50. The second base 60 has an inner surface 60a positioned toward the inside side the air-tight chamber C shown in FIG. 1 and an outer surface 60b on the side opposite to the inner surface 60a. The second base 60 is made of, for example, epoxy resin containing glass.

Further, as shown in FIG. 7B, the second base 60 is formed with a plurality of first plating receiving passageways 63 for interconnecting the inner surface 60a and the outer surface 60b of the second base 60. The plurality of first plating receiving passageways 63 are formed in two lines at positions outside the vias 54 in the width direction of the second base 60. The first plating receiving passageways 63 in each line are formed by applying second conductive sections 62 to inner circumferential faces of receiving passageways 61 extending through between the inner surface 60a and the outer surface 60b of the second base 60. The second conductive section 62 extends between the inner surface 60a and the outer surface 60b of the second base 60. As shown in FIG. 7B, the second conductive section 62 is formed so as to completely fill in the inner space of the receiving passageway 61. The outer surface 60b side of each second conductive section 62 is connected to the second conductive layer 55 connected to the inner surface 60a side of the first conductive section 52 forming the via 54 in the first base 50. Further, a plurality of first conductive layers 64 connected to the inner surface side of the conductive section 62 are provided on the inner surface 60a of the second base 60. The plurality of first conductive layers 64 are formed on the inner surface 60a of the second base 60 in two lines in a width direction. Each first conductive layer 64 is formed in a rectangular shape.

Furthermore, the third base 70 is a flat member with an approximately rectangular shape extending in a width direction (in a horizontal direction in FIG. 7A) and a longitudinal direction (in a vertical direction in FIG. 7A). The third base 70 has a width and a length equal to those of the outer surface 50b of the first base 50. The third base 70 has the inner surface 70a positioned toward the inside side of the air-tight chamber C shown in FIG. 1, and the outer surface 70b on the side opposite to the inner surface 70a. The third base 70 is made of, for example, epoxy resin containing glass.

Further, as shown in FIG. 7B, the third base 70 is formed with a plurality of second plating receiving passageways 73 for interconnecting the inner surface 70a and the outer surface 70b of the third base 70. The plurality of second plating receiving passageways 73 are formed in two lines at positions outside the vias 54 in the width direction of the third base 70. The second plating receiving passageways 73 in each line are formed by applying third conductive sections 72 to inner circumferential faces of receiving passageways 71 extending through between the inner surface 70a and the outer surface 70b of the third base 70. The third conductive section 72 extends between the inner surface 70a and the outer surface 70b of the third base 70. As shown in FIG. 7B, the third conductive section 72 is formed so as to completely fill in the inside of the receiving passageway 71. The inner surface 70a side of each third conductive section 72 is connected to the third conductive layer 56 connected to the outer surface 50b side of the first conductive section 52 forming the via 54 formed in the first base 50. Further, a plurality of fourth conductive layers 74 connected to the outer surface side of the third conductive section 72 are provided on the outer surface 70b of the third base 70. As shown in FIG. 7A, the plurality of fourth conductive layers 74 are formed on the outer surface 70b of the third base 70 in two lines in a width direction. Each fourth conductive layer 74 is formed in a rectangular shape.

Here, as shown in FIG. 7B, by adopting the configuration where the outer surface 60b of the second base 60 comes in contact with the inner surface 50a of the first base 50, the inner surface side of the via 54 formed in the first base 50 is closed by the second base 60. Further, by adopting the configuration where the inner surface 70a of the third base 70 comes in contact with the outer surface 50b of the first base 50, the outer surface side of the via 54 formed in the first base 50 is closed by the third base 70.

Incidentally, the electrical connection portion connecting the first conductive layer 64, the second conductive layer 55, the third conductive layer 56, and the fourth conductive layer 74 is composed of the above-described first plating receiving passageway 63, via 54, and second plating receiving passageway 73.

As shown in FIG. 7B, a soldering layer 17 is formed on whole circumferences of end faces of the first base 50, the second base 60, and the third base 70. The soldering layer 17 extends from the inner surface 60a of the second base 60 to reach the outer surface 70b of the third base 70.

In this manner, the flat connector 2 is composed of the four-layer board and the soldering layer 17 is formed on the whole circumferences of end faces of the first base 50, the second base 60, and the third base 70. Therefore, the soldering layer 17 is soldered to the inner wall of the receiving space 41 by solder where the base 10 of the flat connector 2 has been disposed within the receiving space 41. Thereby, the flat connector 2 is secured to the inner wall of the receiving space 41 and the receiving space 41 is closed by the flat connector 2. Therefore, in the bulkhead mounting structure 1 where the flat connector 2 has been secured to the bulkhead 40, the thickness of the bulkhead 40 and the thickness of the flat connector 2 overlap with each other in the receiving space 41 of the bulkhead 40. Thereby, the thickness of the bulkhead mounting structure 1 where the flat connector 2 composed of the four-layer board has been attached to the bulkhead 40 along the thickness direction of the bulkhead 40 can be made thin so that height reduction of the bulkhead mounting structure 1 can be achieved.

Furthermore, since the soldering layer 17 of the flat connector 2 is provided on the whole faces of the end faces of the first base 50, the second base 60, and the third base 70 forming the base 10, soldering is performed on the whole circumference of the inner wall of the receiving space 41. Therefore, the flat connector 2 can be secured to the inner wall of the receiving space 41. Further, a gap between the whole circumference of the end face 10c of the base 10 and the whole circumference of the inner wall of the receiving space 41 can be filled with solder, and when gas which has been filled in the inside of the air-tight chamber C moves from the inside of the air-tight chamber C toward the outside thereof, movement thereof can be blocked effectively by the solder.

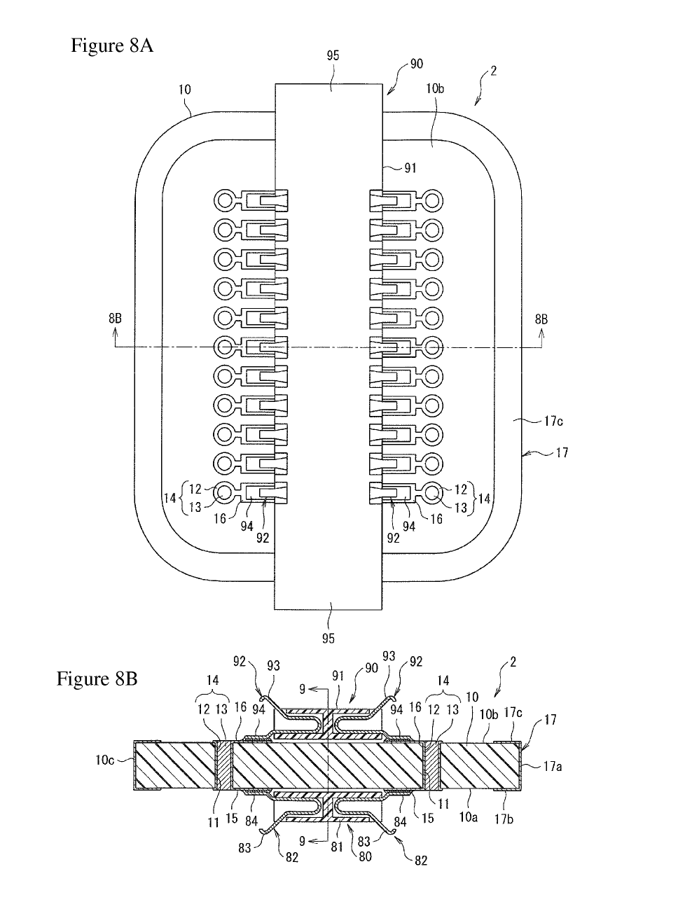

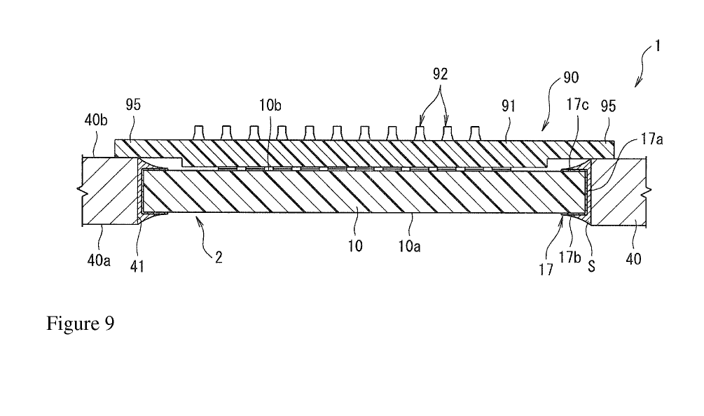

Next, with reference to FIGS. 8A and 8B, and FIG. 9, a first connector and a second connector mounted on the flat connector according to the invention will be described.

In FIGS. 8A and 8B, and FIG. 9, same members as those in FIG. 1 and FIGS. 2A and 2B are used with same reference numerals and explanation thereof may be omitted.

A flat connector 2 shown in FIGS. 8A and 8B has the same configuration as that of the flat connector 2 shown in FIGS. 2A and 2B. A first connector 80 is mounted on an inner surface 10a of a base 10 forming the flat connector 2, while a second connector 90 is mounted on an outer surface 10b of the base 10.

Here, the first connector 80 includes an insulating housing 81 and a plurality of contacts attached to the housing 81 in two lines. Although not illustrated, the housing 81 has an approximately rectangular parallelepiped shape extending in an elongated fashion in a longitudinal direction (in a vertical direction in FIG. 8A). The length of the housing 81 in a longitudinal direction thereof is shorter than the length of the flat connector 2 in the longitudinal direction thereof and it can pass through the receiving space 41 of the bulkhead 40.

Further, the plurality of contacts 82 are arranged in two lines in the width direction of the base 10 corresponding to the plurality of inner conductive layers 15 of the flat connector 2. Each contact 82 includes a contact portion 83 contacting with an conductive pad (not shown) formed on the surface of the first circuit board 20 shown in FIG. 1 and a connection portion 84 connected to the inner conductive layer 15 by soldering. Each contact 82 is formed by stamping and forming a metal plate.

On one hand, the second connector 2 includes an insulating housing 91 and a plurality of contacts 92 attached to the housing 91 in two lines. As shown in FIG. 8A, the housing 91 has an approximately rectangular parallelepiped shape extending in an elongated fashion in a longitudinal direction (in a vertical direction in FIG. 8A). The length of the housing 91 in a longitudinal direction thereof is longer than the length of the flat connector 2 in the longitudinal direction thereof, and a pair of positioning portions 95 projecting from the flat connector 2 is provided at both ends of the housing 91 in the longitudinal direction. The positioning portions 95 abuts on the outer surface 40b of the bulkhead 40 to position the flat connector 2 to the bulkhead 40 when the flat connector 2 is disposed within the receiving space 41.

Further, the plurality of contacts 92 are disposed in two lines in the width direction of the base 10 corresponding to the plurality of outer conductive layers 16 of the flat connector 2. Each contact 92 has a contact portion 93 contacting with an conductive pad (not shown) formed on the surface of the second circuit board 30 shown in FIG. 1, and a connection portion 94 connected to the outer conductive layer 16 by solder. Each contact 92 is formed by stamping and forming a metal plate.

A method for performing electrical interconnection using the flat connector 2 and the first connector 80 and the second connector 90 mounted on the flat connector 2 will be described with reference to FIG. 1.

As shown in FIG. 1, a circuit board without the contacts 21 is used as the first circuit board 20, and one without the contacts 31 is used as the second circuit board 30.

As shown in FIG. 1, first, the first circuit board 20 is disposed within the air-tight chamber C. Next, the base 10 of the flat connector 2 is disposed within the receiving space 41 of the bulkhead 40 such that the inner surface 10a of the flat connector 2 is directed to the inside of the air-tight chamber C, as shown in FIG. 9. At this time, each positioning portion 95 of the second connector 90 mounted on the flat connector 2 abuts on outer surface 40b of the bulkhead 40 to position the flat connector 2 to the bulkhead 40. Therefore, a jig for positioning the flat connector 2 is not required. In this state, the soldering layer 17 of the flat connector 2 is soldered to the inner wall of the receiving space 41 by solder S. Thereby, the flat connector 2 is secured to the inner wall of the receiving space 41 and the receiving space 41 is closed by the flat connector 2. Further, the contacts 82 of the first connector 80 mounted on the flat connector 2 come in contact with the conductive pads provided on the first circuit board 20.

Next, the conductive pads formed on the second circuit board 30 contact with the contacts 92 of the second connector 90. Thereby, the first circuit board 20 and the second circuit board 30 are electrically interconnected to each other through the flat connector 2, the first connector 80, and the second connector 90.

Further, as described above, the positioning portions 95 of the second connector 90 mounted on the flat connector 2 abut on the outer surface 40b of the bulkhead 40 to position the flat connector 2 to the bulkhead 40. Therefore, a jig for positioning the flat connector 2 is not be required, which is different from the first embodiment of the bulkhead mounting structure shown in FIG. 1 to FIG. 3.

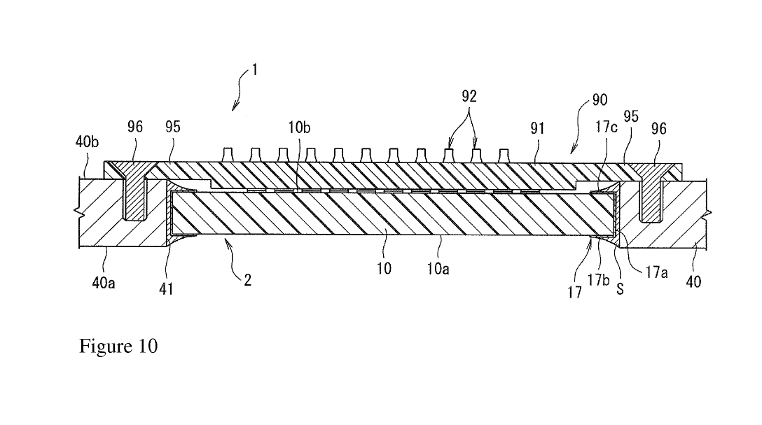

A bulkhead mounting structure 1 shown in FIG. 10 is different from the bulkhead mounting structure 1 shown in FIG. 9 in that each positioning portions 95 have been attached to the outer surface 40b of the bulkhead 40 by an attaching screw (fixture) 96.

By attaching each positioning portion 95 of the second connector 90 to the outer surface 40b of the bulkhead 40 using the attaching screw 96 in this manner, the whole second connector 90 having the positioning portions 95 and the flat connector 2 are secured to the bulkhead 40 when the flat connector 2 is disposed within the receiving space 41 of the bulkhead 40. Therefore, positioning of the flat connector 2 performed by the positioning portions 95 when the flat connector 2 is disposed within the receiving space 41 of the bulkhead 40 can be performed securely and easily.

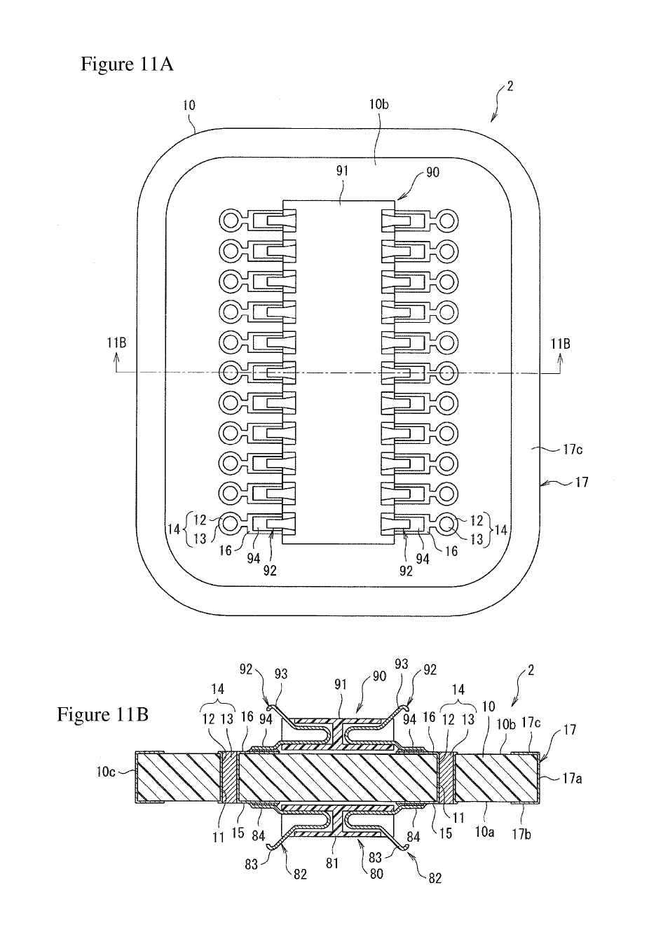

A flat connector 2 shown in FIGS. 11A and 11B has the same configuration as that of the flat connector 2 shown in FIGS. 8A and 8B. In FIGS. 11A and 11B, same members as the members in FIGS. 8A and 8B are used with same reference numerals and explanation thereof may be omitted.

A first connector 80 is mounted on the inner surface 10a of the base 10 forming the flat connector 2, while a second connector 90 is mounted on the outer surface 10b of the base 10.

Here, a configuration and a shape of the first connector 80 shown in FIGS. 11A and 11B are the same as those of the first connector 80 shown in FIGS. 8A and 8B. However, a configuration and a shape of the second connector 90 shown in FIGS. 11A and 11B are different from the configuration and the shape of the second connector 90 shown in FIGS. 8A and 8b.

That is, the second connector 90 shown in FIGS. 11A and 11B has the same configuration and shape as those of the first connector 80, and a pair of positioning portions 95 projecting from the flat connector 2 are not provided on both ends of the housing 91 in the longitudinal direction thereof.

The second connector 90 does not have the positioning portions 95. When the base 10 is disposed within the receiving space 41, positioning of the flat connector 2 to the bulkhead 40 is performed using a jig (not shown) like the flat connector 2 shown in FIGS. 2A and 2B. The soldering layer 17 of the flat connector 2 is soldered to the inner wall of the receiving space 41 by solder. Thereby, the flat connector 2 is secured to the inner wall of the receiving space 41 and the receiving space 41 is closed by the flat connector 2. Further, the contacts 82 of the first connector 80 mounted on the flat connector 2 come in contact with conductive pads provided on the first circuit board 20.

Next, conductive pads formed on the second circuit board 30 make contact with the contacts 92 of the second connector 90. Thereby, the first circuit board 20 and the second circuit board 30 are electrically interconnected to each other through the flat connector 2, the first connector 80, and the second connector 90.

Even if the thickness of the bulkhead 40 and the thickness of the flat connector 2 overlap with each other in the receiving space 41 of the bulkhead 40, the thickness of the bulkhead mounting structure 1 in the thickness direction of the bulkhead 40 can be made thin.

Although the embodiments of the invention have been described above, the present invention is not limited to these embodiments but it may be modified or improved variously.

For example, the soldering layer 17 may be provided on the whole circumference of the end face 10c of the base 10 in the double-sided board, as described above, and it is not required to be provided on the peripheral edge of the inner surface 10a of the base 10 or the peripheral edge of the outer surface 10b of the base 10 necessarily. That is, the soldering layer 17 may take the following forms: (1) the soldering layer 17 is composed of only the first soldering layer 17a, (2) the soldering layer 17 is composed of the first soldering layer 17a and the second soldering layer 17b, (3) the soldering layer 17 is composed of the first soldering layer 17a and the third soldering layer 17c, or (4) the soldering layer 17 is composed of the first soldering layer 17a, the second soldering layer 17b, and the third soldering layer 17c.

Further, in the case of the four-layer board, the example where the soldering layer 17 is provided on the whole circumference of the end face of the base 10 has been described, but in addition thereto, the soldering layer 17 may be provided on the whole circumference of the peripheral edge of the inner surface 60a of the second base 60 of the base 10 or on the whole circumference of the peripheral edge of the outer surface 70b of the third base 70 of the base 10. That is, even in the four-layer board, the soldering layer 17 may take the following four forms: (1) the soldering layer 17 is composed of the first soldering layer provided on the whole circumference of the end face of the base 10, (2) the soldering layer 17 is composed of the first soldering layer and the second soldering layer continuous with the first soldering layer and provided on the whole circumference of the peripheral edge of the inner surface 60a of the second base 60, (3) the soldering layer 17 is composed of the first soldering layer and the third soldering layer continuous with the first soldering layer and provided on the whole circumference of the peripheral edge of the outer surface 70b of the third base 70, or (4) the soldering layer 17 is composed of the first soldering layer, the second soldering layer, and the third soldering layer.

Further, in the double-sided board, when the soldering layer 17 is provided on the whole circumference of the end face 10c of the base 10, the soldering layer 17 is not required to extend from the inner surface 10a of the base 10 to reach the outer surface 10b thereof necessarily. Further, in the four-layer board, when the soldering layer 17 is provided on the whole circumference of the end face of the base 10, the soldering layer 17 is not required to extend from the inner surface 60a of the second base 60 to reach the outer surface 70b of the third base 70 necessarily.

Furthermore, although the example where the multilayer board is the four-layer board has been described, the multilayer board is not limited to the four-layer board but it may be a multilayer board composed of six or more base layers.

Further, when the flat connector 2 is composed of the multilayer board of four or more boards, the filler 53 is not required to be filled in the first conductive section 52 of the via 54 necessarily.

Further, in the FIGS. 8A and 8B, FIG. 9 and FIG. 10, the positioning portion 95 is provided integrally with the housing 91 of the second connector 90, but if the flat connector 2 can be positioned to the bulkhead 40, the positioning portion 95 may be provided as a separate member from the housing 91.

In addition, the example where the first connector 80 and the second connector 90 have been mounted to the inner surface 10a and the outer surface 10b of the base 10 forming the flat connector 2 has been described, but simple metal-made terminals may be mounted on the inner surface 10a and the outer surface 10b of the base 10 instead of the first connector 80 and the second connector 90.

The foregoing illustrates some of the possibilities for practicing the invention. Many other embodiments and fields of use for the bulkhead mounting structure 1 and the flat connector 2 are possible and within the scope and spirit of the invention. It is, therefore, intended that the foregoing description be regarded as illustrative rather than limiting, and that the scope of the invention is given by the appended claims together with their full range of equivalents.

What is claimed is:

1. A flat connector comprising:
a base having an end face, an inner surface located adjacent the end face, and an outer surface located opposite the inner surface;
an electrical connection portion electrically connecting the inner surface and the outer surface and; and
a soldering layer provided along the end face.

2. The flat connector according to claim 1, wherein the soldering layer includes a first soldering layer disposed along the end face.

3. The flat connector according to claim 2, wherein the soldering layer further includes a second soldering layer continuous with the first soldering layer.

4. The flat connector according to claim 3, wherein the soldering layer further includes a third soldering layer continuous with the first soldering layer.

5. The flat connector according to any of claim 4, wherein the base is a double-sided board having two conductive layers connected to the inner surface and the outer surface by the electrical connection portion.

6. The flat connector according to claim 2, wherein the soldering layer further includes a third soldering layer continuous with the first soldering layer.

7. The flat connector according to claim 1, wherein the base is a double-sided board having two conductive layers connected to the inner surface and the outer surface by the electrical connection portion.

8. The flat connector according to claim 1, wherein the base includes a multilayer board having a plurality of conductive layers in which an inner surface of an innermost layer of the plurality of conductive layers, an outer surface of an outermost layer of the plurality of conductive layers, and adjacent layers within of the plurality of conductive layers are interconnected by the electrical connection portion.

9. The flat connector according to claim 1, further comprising a receiving passageway extending through and between the inner surface and the outer surface.

10. The flat connector according to claim 9, wherein the electrical connection portion includes a conductive section provided on an inner face of the receiving passageway.

11. The flat connector according to claim 10, further comprising a filler disposed in the conductive section.

12. The flat connector according to claim 11, wherein the filler includes a resin.

13. A bulkhead mounting structure, comprising
a bulkhead having a receiving space leading into a chamber; and
a flat connector having:
a base having an end face, an inner surface positioned adjacent the end face, and an outer surface positioned opposite the inner surface;
an electrical connection portion electrically connecting the inner surface and the outer surface and;
a soldering layer disposed along the end face.

14. The bulkhead mounting structure according to claim 13, further comprising a separate connector mounted on the flat connector and abutting a face of the bulkhead.

15. The bulkhead mounting structure according to claim 14, wherein the separate connector is attached to the bulkhead by a fixture.

16. The bulkhead mounting structure according to claim 13, wherein the soldering layer includes a first soldering layer provided along the end face.

17. The bulkhead mounting structure according to claim 16, wherein the soldering layer further includes a second soldering layer continuous with the first soldering layer and formed on a peripheral edge of the inner surface.

18. The bulkhead mounting structure according to claim 17, wherein the soldering layer further includes a third soldering layer continuous with the first soldering layer and formed on a peripheral edge of the outer surface.

19. The bulkhead mounting structure according to claim 13, further comprising a receiving passageway extending through and between the inner surface and the outer surface.

20. The bulkhead mounting structure according to claim 19, wherein the electrical connection portion includes a conductive section located on an inner face of the receiving passageway.

21. The bulkhead mounting structure according to claim 20, further comprising a filler disposed in the conductive section.
